(19) United States
(12) Patent Application Publication
(10) Pub. No.: US 2022/0200045 A1
(43) Pub. Date: Jun. 23, 2022

(54) ALL-SOLID-STATE BATTERY AND METHOD FOR MANUFACTURING SAME

(71) Applicant: Panasonic Intellectual Property Management Co., Ltd., Osaka (JP)

(72) Inventors: SHUZO TSUCHIDA, Nara (JP); AKIHIRO HORIKAWA, Osaka (JP)

(21) Appl. No.: 17/529,340

(22) Filed: Nov. 18, 2021

(30) Foreign Application Priority Data
Dec. 23, 2020 (JP) 2020-213644

(51) Int. Cl. H01M 10/0562; H01M 4/36; H01M 10/0525; H01M 4/139; H01M 4/04; H01M 4/62

(52) U.S. Cl. CPC H01M 10/0562; H01M 4/366; H01M 4/621; H01M 4/139; H01M 4/043; H01M 10/0525

(57) ABSTRACT

All-solid-state battery 100 has a structure in which positive electrode current collector 7, positive electrode layer 20 containing positive electrode active material 3, solid electrolyte 1 including a plurality of first particles having a first average particle diameter, and solid electrolyte 2 composed of a plurality of second particles having second average particle diameter larger than the first average particle diameter, solid electrolyte layer 10 containing solid electrolyte 6, negative electrode layer 30 containing negative electrode active material 4 and solid electrolyte 5, and negative electrode current collector 8 are stacked in this order, in which at least a part of solid electrolyte 1 serves as a cover layer 11 covering at least a part of a surface of positive electrode active material 3, and at least one of the plurality of second particles are partially embedded in cover layer 11.

### BACKGROUND

### 1. Technical Field

The present disclosure relates to an all-solid-state battery and a method for manufacturing the same, and more particularly to an all-solid-state battery using a positive electrode layer, a negative electrode layer, and a solid electrolyte layer, and a method for manufacturing the same.

### 2. Description of the Related Art

In recent years, development of a secondary battery that can be repeatedly used has been required due to weight reduction, cordless extension, or the like of electronic devices such as personal computers and mobile phones. Examples of the secondary battery include a nickel-cadmium battery, a nickel hydrogen battery, a lead-acid battery, and a lithium-ion battery. Among these batteries, the lithium ion battery has characteristics such as a light weight, a high voltage, and a high energy density, and is thus attracting attention.

In an automobile field such as an electric vehicle or a hybrid vehicle, the development of a secondary battery having a high battery capacity is important, and a demand for the lithium ion battery tends to increase.

The lithium ion battery is formed of a positive electrode layer, a negative electrode layer, and an electrolyte disposed between the positive electrode layer and the negative electrode layer, and a solid electrolyte or an electrolyte solution obtained by dissolving a supporting salt such as lithium hexafluorophosphate in an organic solvent is used for the electrolyte. Currently, a widely used lithium ion battery is combustible since the electrolytic solution containing the organic solvent is used. Therefore, a material, a structure, and a system for ensuring the safety of the lithium ion battery are required. On the other hand, it is expected that by using a nonflammable solid electrolyte as the electrolyte, the material, the structure, and the system described above can be simplified, and it is thought that an energy density can be increased, a manufacturing cost can be reduced, and productivity can be improved. Hereinafter, a battery using the solid electrolyte, such as the lithium ion battery using the solid electrolyte, will be referred to as an “all-solid-state battery”.

The solid electrolyte can be roughly divided into an organic solid electrolyte and an inorganic solid electrolyte. The organic solid electrolyte has an ion conductivity of about 10⁻⁶ S/cm at 25° C., the ion conductivity is extremely low as compared with an ion conductivity of about 10⁻³ S/cm of an electrolytic solution. Therefore, it is difficult to operate the all-solid-state battery using the organic solid electrolyte in an environment of 25° C. As the inorganic solid electrolyte, an oxide-based solid electrolyte, a sulfide-based solid electrolyte, and a halide-based solid electrolyte are generally used. The ion conductivity of these solid electrolytes is about 10⁻⁴ S/cm to 10⁻³ S/cm, which is a relatively high ion conductivity. Therefore, in the development of the all-solid-state battery directed to a large size and a high capacity, studies of an all-solid-state battery enabling a large size using a sulfide-based solid electrolyte or the like have been actively conducted in the recent years.

For example, Japanese Patent No. 6222299 discloses a technique relating to a configuration of an all-solid-state battery containing a positive electrode active material and a solid electrolyte in a positive electrode layer.

### SUMMARY

An all-solid-state battery according to an aspect of the present disclosure includes: a positive electrode current collector; a positive electrode layer containing a positive electrode active material, a first solid electrolyte including a plurality of first particles having a first average particle diameter, and a second solid electrolyte including a plurality of second particles having a second average particle diameter larger than the first average particle diameter; a solid electrolyte layer containing a fourth solid electrolyte; a negative electrode layer containing a negative electrode active material and a third solid electrolyte; and a negative electrode current collector, in which the positive electrode current collector, the positive electrode layer, the solid electrolyte layer, the negative electrode layer, and the negative electrode current collector are stacked in this order, at least a part of the first solid electrolyte serves as a cover layer covering at least a part of a surface of the positive electrode active material, and at least one of the plurality of second particles are partially embedded in the cover layer.

### BRIEF DESCRIPTION OF THE DRAWINGS

FIG. 1 is a schematic view showing a cross section of an all-solid-state battery according to an embodiment;

FIG. 2 is a schematic cross-sectional view illustrating a method for manufacturing an all-solid-state battery according to the embodiment;

FIG. 3 is a flowchart showing a mixing procedure in the method for manufacturing an all-solid-state battery according to the embodiment;

FIG. 4 is a flowchart showing a mixing procedure in a method for manufacturing an all-solid-state battery according to a comparative example;

FIG. 5 is a schematic view showing a positional relationship between a positive electrode active material and a solid electrolyte obtained by the method for manufacturing an all-solid-state battery according to the embodiment;

FIG. 6 is a schematic view showing a positional relationship between a positive electrode active material and a solid electrolyte obtained by the method for manufacturing an all-solid-state battery according to the comparative example; and

FIG. 7 is Table 1 showing results of evaluating a charge and discharge efficiency, as battery characteristics, of all-solid-state batteries in Example 1 and Comparative Example 1.

### DETAILED DESCRIPTION

In a method for manufacturing an all-solid-state battery described in Japanese Patent No. 6222299, a positive electrode active material, first particles made of a solid electrolyte material, and conductive particles are stirred and mixed to form a first conductive layer formed of the first particles and the conductive particles on a surface of the positive electrode active material. Composite particles on which the first conductive layer is formed, second particles made of a solid electrolyte material, and the conductive particles are mixed and charged into a predetermined mold and subjected to compression molding to form a positive electrode layer.

However, this method has the following two problems. The first problem is that, when the composite particles, the second particles, and the conductive particles are mixed and charged into the mold, the second particles are aggregated, so that a location where a large amount of the second particles are present is partially present inside the positive electrode layer. On the contrary, a location where the number of the second particles is small is also partially present, and a space formed between the composite particles is not filled with the second particles. As a result, there is a problem that a utilization efficiency of the positive electrode active material is reduced, thereby reducing battery characteristics in low rate charge and discharge.

The second problem is that, in the first conductive layer, a large number of minute spaces and interfaces are present between the first particles. Therefore, there is a problem that the space and the interface reduce conductivity of ions and hinder ion conduction from the surface of the positive electrode active material to the second particles, thereby reducing the battery characteristics in high rate charge and discharge.

The present disclosure has been made in view of the above problems, and an object of the present disclosure is to provide an all-solid-state battery or the like in which a decrease in battery characteristics is prevented.

An all-solid-state battery according to an aspect of the present disclosure has a structure in which a positive electrode current collector, a positive electrode layer containing a positive electrode active material, a first solid electrolyte including a plurality of first particles having a first average particle diameter, and a second solid electrolyte including a plurality of particles having a second average particle diameter larger than the first average particle diameter, a solid electrolyte layer containing a fourth solid electrolyte, a negative electrode layer containing a negative electrode active material and a third solid electrolyte, and a negative electrode current collector are stacked in this order, in which at least a part of the first solid electrolyte serves as a cover layer covering at least a part of a surface of the positive electrode active material, and at least one of the plurality of second particles are partially embedded in the cover layer.

According to the all-solid-state battery or the like of the present disclosure, it is possible to prevent the decrease in battery characteristics.

Specifically, since the second solid electrolyte is embedded in the cover layer, the second solid electrolyte is likely to be fixed in the vicinity of the surface of the positive electrode active material. As a result, aggregation of the second solid electrolyte in the positive electrode layer is prevented, and a gap between the positive electrode active materials in the positive electrode layer is likely to be filled with the second solid electrolyte. Therefore, an ion conduction path between the positive electrode active materials in the positive electrode layer is likely to be uniformly formed, the utilization efficiency of the positive electrode active material is improved, and the decrease in battery characteristics of the all-solid-state battery in low rate charge and discharge can be prevented.

For example, a shortest distance between a surface of the at least one of the plurality of second particles and the at least a part of the surface of the positive electrode active material covered by the cover layer may be shorter than an average thickness of the cover layer.

Accordingly, the surface of bulk particles of the second solid electrolyte, in which ions are more likely to be conducted than in the cover layer having ion conductivity likely to be reduced due to an influence of a particle interface and the like, approaches the vicinity of the surface of the positive electrode active material. Therefore, a distance that the ions pass through the cover layer is shortened, and a decrease in ion conductivity of the entire positive electrode layer can be prevented. Therefore, it is possible to prevent the decrease in battery characteristics of the all-solid-state battery in high rate charge and discharge.

For example, a depth at which the at least one of the plurality of second particles is embedded may be 10% or more of the second average particle diameter.

Accordingly, an effect of preventing detachment of the second solid electrolyte in a process of manufacturing the all-solid-state battery can be easily obtained, and the particles of the second solid electrolyte are stably fixed on the cover layer, so that it is possible to form a positive electrode layer in which high dispersibility of the second solid electrolyte is realized. Therefore, it is possible to further prevent the decrease in battery characteristics of the all-solid-state battery in low rate charge and discharge. Further, in the cover layer formed on the surface of the positive electrode active material, the surface of the positive electrode active material and the surface of the particles of the second solid electrolyte embedded in the cover layer are likely to approach each other, so that the decrease in ion conductivity of the entire positive electrode layer can be further prevented, and the decrease in battery characteristics of the all-solid-state battery in high rate charge and discharge can be further prevented.

For example, the second average particle diameter may be five times or more the first average particle diameter.

Accordingly, since the average particle diameter of the second solid electrolyte is increased, the aggregation of the particles of the second solid electrolyte in manufacturing the positive electrode layer is prevented, and the particles of the second solid electrolyte are prevented from being completely embedded in the cover layer. Therefore, the gap between the positive electrode active materials is likely to be filled with the second solid electrolyte efficiently.

In addition, a method for manufacturing an all-solid-state battery according to an aspect of the present disclosure includes: a first mixing step of mechanically applying a compressive force and a shearing force to the positive electrode active material and the first solid electrolyte; and a second mixing step of further adding the second solid electrolyte to a mixture of the positive electrode active material and the first solid electrolyte after the first mixing step and mechanically applying a compressive force and a shearing force, in which energy used for applying the compressive force and the shearing force in the first mixing step is larger than energy used for applying the compressive force and the shearing force in the second mixing step.

Through the first mixing step, the cover layer composed of the particles of the first solid electrolyte is likely to be formed on the surface of the positive electrode active material. In addition, through the second mixing step of applying the compressive force and the shearing force at energy lower than the energy in the first mixing step, it is possible to embed the particles of the second solid electrolyte in the cover layer while preventing grinding of the particles of the second solid electrolyte.

Hereinafter, the all-solid-state battery according to an embodiment will be described in detail. Each of the embodiments described below shows a comprehensive or specific example. Numerical values, shapes, materials, constituent elements, arrangement positions and connection forms of the constituent elements, processes, and the like described in the following embodiments are examples, and are not intended to limit the present disclosure.

In the present specification, terms indicating a relationship between elements such as parallel, terms indicating a shape of elements such as rectangles, and numerical value ranges are not expressions expressing only strict meanings, and are expressions that mean substantially equivalent ranges, which cover, for example, a difference of about several percent.

Each drawing is a schematic view that is appropriately emphasized, omitted, or adjusted in proportion to show the present disclosure, and is not necessarily exactly illustrated and may differ from an actual shape, positional relationship, and ratio. In the drawings, substantially the same components are denoted by the same reference numerals, and redundant description may be omitted or simplified.

In the present specification, terms “up” and “down” in the configuration of the all-solid-state battery do not refer to an upward direction (vertically upward direction) and a downward direction (vertically downward direction) in absolute space recognition, and are used as terms that are defined by a relative positional relationship based on a stacking order in a stacked configuration. Further, the terms “up” and “down” are applied not only to a case where two constituent elements are arranged in close contact with each other and the two constituent elements come into contact with each other, but also to a case where two constituent elements are arranged with a gap therebetween and another constituent element is present between two constituent elements.

In the present specification, a cross-sectional view is a view showing a cross section in a case where a central portion of the all-solid-state battery is cut in a stacking direction.

### Embodiment

### Configuration

### A. All-Solid-State Battery

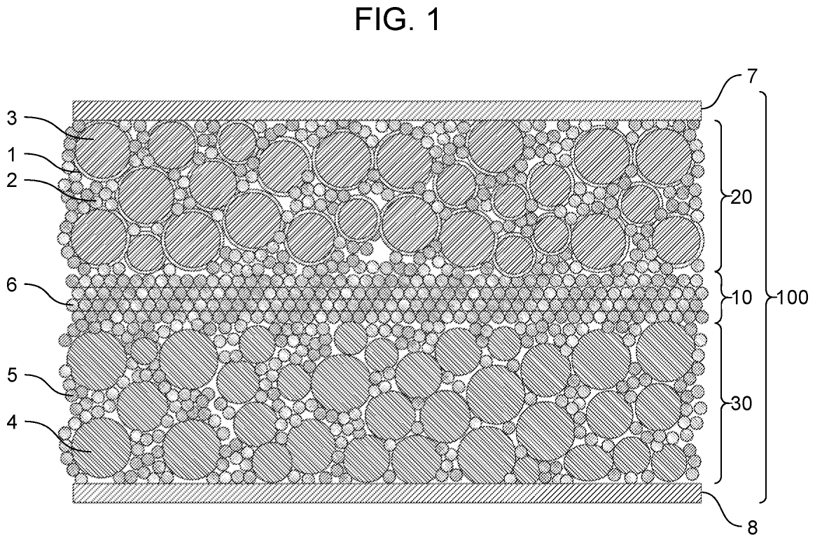

The all-solid-state battery according to the present embodiment will be described with reference to FIG. 1. FIG. 1 is a schematic view showing a cross section of all-solid-state battery 100 according to the present embodiment. All-solid-state battery 100 according to the present embodiment includes positive electrode current collector 7, negative electrode current collector 8, positive electrode layer 20 formed on a surface of positive electrode current collector 7 close to negative electrode current collector 8 and containing positive electrode active material 3, solid electrolyte 1 composed of a plurality of particles, and solid electrolyte 2 composed of a plurality of particles having an average particle diameter larger than that of solid electrolyte 1, negative electrode layer 30 formed on a surface of negative electrode current collector 8 close to positive electrode current collector 7 and containing negative electrode active material 4 and solid electrolyte 5, and solid electrolyte layer 10 disposed between positive electrode layer 20 and negative electrode layer 30 and containing at least solid electrolyte 6 having ion conductivity. In other words, all-solid-state battery 100 has a structure in which positive electrode current collector 7, positive electrode layer 20, solid electrolyte layer 10, negative electrode layer 30, and negative electrode current collector 8 are stacked in this order. In the present embodiment, solid electrolyte 1 is an example of the first solid electrolyte, solid electrolyte 2 is an example of the second solid electrolyte, solid electrolyte 5 is an example of the third solid electrolyte, and solid electrolyte 6 is an example of the fourth solid electrolyte.

Regarding a positional relationship among positive electrode active material 3, solid electrolyte 1, and solid electrolyte 2 in positive electrode layer 20 in the present embodiment, the cover layer formed by solid electrolyte 1 (specifically, collection of the plurality of particles of solid electrolyte 1) is formed on the at least a part of the surface of positive electrode active material 3, and the at least a part of particles of the plurality of particles constituting solid electrolyte 2 are partially embedded in a form of piercing the cover layer. In FIG. 1, illustration of a shape of the plurality of particles of solid electrolyte 1 is omitted, and a form of the cover layer formed by concentration of the plurality of particles of solid electrolyte 1 is shown.

All-solid-state battery 100 is formed by the following method, for example. First, positive electrode layer 20 formed on positive electrode current collector 7 made of a metal foil and containing positive electrode active material 3, negative electrode layer 30 formed on negative electrode current collector 8 made of a metal foil and containing negative electrode active material 4, and solid electrolyte layer 10 disposed between positive electrode layer 20 and negative electrode layer 30 and containing solid electrolyte 6 having ion conductivity are formed. Then, pressing is performed from outer sides of positive electrode current collector 7 and negative electrode current collector 8 at a pressure of, for example, 100 MPa or more and 1000 MPa or less, and a filling rate of at least one layer of layers is 60% or more and less than 100%, whereby all-solid-state battery 100 is obtained. By setting the filling rate to 60% or more, since voids are reduced in solid electrolyte layer 10, positive electrode layer 20, or negative electrode layer 30, lithium (Li) ion conduction and electron conduction are often performed, and good charge and discharge characteristics can be obtained. The filling rate is a ratio of a volume occupied by the material excluding the voids between the materials to a total volume in each layer.

Pressed all-solid-state battery 100 is attached with a terminal, for example, and is housed in a case. As the case of all-solid-state battery 100, for example, an aluminum laminate bag, a metal case such as stainless steel (SUS), iron or aluminum, or a resin case is used.

Hereinafter, solid electrolyte layer 10, positive electrode layer 20, and negative electrode layer 30 of all-solid-state battery 100 in the present embodiment will be described.

### B. Solid Electrolyte Layer

First, solid electrolyte layer 10 will be described. Solid electrolyte layer 10 in the present embodiment contains solid electrolyte 6, and may further contain a binder.

### B-1. Solid Electrolyte

Solid electrolyte 6 in the present embodiment will be described. Examples of the solid electrolyte material used for solid electrolyte 6 include a sulfide-based solid electrolyte, a halide-based solid electrolyte, and an oxide-based solid electrolyte, which are commonly known materials. As the solid electrolyte material, any of the sulfide-based solid electrolyte, the halide-based solid electrolyte, and the oxide-based solid electrolyte may be used. A type of the sulfide-based solid electrolyte in the present embodiment is not particularly limited. Examples of the sulfide-based solid electrolyte include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. In particular, since the ion conductivity of lithium is excellent, the sulfide-based solid electrolyte preferably contains Li, P, and S. Further, the sulfide-based solid electrolyte may contain P₂S₅ since reactivity with the binder is high and bondability with the binder is high. The above description of “Li₂S—P₂S₅” means a sulfide-based solid electrolyte using a raw material composition containing Li₂S and P₂S₅, and the same applies to other descriptions.

In the present embodiment, the sulfide-based solid electrolyte is, for example, a sulfide-based glass ceramic containing Li₂S and P₂S₅, and a ratio of Li₂S and P₂S₅ may be in a range of 70:30 to 80:20 or in a range of 75:25 to 80:20 for Li₂S:P₂S₅ in terms of molars. By setting the ratio of Li₂S and P₂S₅ within the above range, a crystal structure having high ion conductivity can be obtained while maintaining a Li concentration that influences the battery characteristics. Further, by setting the ratio of Li₂S and P₂S₅ within the above range, an amount of P₂S₅ for reacting with and binding to the binder is likely to be ensured.

Solid electrolyte 6 is composed of, for example, a plurality of particles. Here, in order to ensure a contact surface with positive electrode active material 3 in positive electrode layer 20 to be described later, the average particle diameter of solid electrolyte 6 is smaller than an average particle diameter of positive electrode active material 3, for example. In the present specification, the average particle diameter is a number average particle diameter obtained by obtaining Feret diameters of the particles from an image obtained by image observation with an electron microscope, and obtaining a number average.

When the particle diameter of solid electrolyte 6 is small, the particle interface in solid electrolyte layer 10 increases, and the particle interface becomes a resistance component, and as a result, there is a concern that the ion conductivity of entire solid electrolyte layer 10 is reduced. Therefore, in order to increase the ion conductivity of solid electrolyte layer 10, it is desirable that the average particle diameter of solid electrolyte 6 is a certain size or more. The average particle diameter of solid electrolyte 6 is, for example, 0.2 μm or more and 10 μm or less.

### B-2. Binder

The binder in the present embodiment will be described. The binder is an adhesive material that does not have ion conductivity and electron conductivity and plays a role of bonding the materials in solid electrolyte layer 10 and solid electrolyte layer 10 to other layers. As the binder, a known binder for a battery is used. In addition, the binder in the present embodiment may contain a thermoplastic elastomer in which a functional group for improving adhesion strength is introduced. In addition, the functional group may be a carbonyl group. From the viewpoint of improving the adhesion strength, the carbonyl group may be maleic anhydride. Oxygen atoms of the maleic anhydride of the binder react with solid electrolyte 6 to bond solid electrolytes 6 to each other via the binder, thereby forming a structure in which the binder is disposed between the plurality of particles of solid electrolytes 6. As a result, the adhesion strength is improved.

Examples of the thermoplastic elastomer include styrene-butadiene-styrene (SBS) and styrene-ethylene-butadiene-styrene (SEBS). These materials can be used since these materials have high adhesion strength and have high durability even in cycle characteristics of the battery. As the thermoplastic elastomer, a hydrogenation-added (hereinafter, hydrogenated) thermoplastic elastomer may be used. By using the hydrogenated thermoplastic elastomer, the reactivity and the bondability are improved, and solubility in a solvent used for forming solid electrolyte layer 10 is improved.

An addition amount of the binder is, for example, 0.01 mass % or more and 5 mass % or less, may be 0.1 mass % or more and 3 mass % or less, and may be 0.1 mass % or more and 1 mass % or less. When the addition amount of the binder is set to 0.001 mass % or more, bonding via the binder is likely to occur, and sufficient adhesion strength is likely to be obtained. In addition, when the addition amount of the binder is set to 5 mass % or less, the decrease in battery characteristics such as charge and discharge characteristics is unlikely to occur, and, even when physical properties such as hardness, tensile strength, and tensile elongation of the binder are changed in a low temperature region, for example, the charge and discharge characteristics are unlikely to decrease.

### C. Positive Electrode Layer

Next, positive electrode layer 20 in the present embodiment will be described. Positive electrode layer 20 in the present embodiment contains solid electrolyte 1, solid electrolyte 2 and positive electrode active material 3. If necessary, a binder and a conductive aid such as acetylene black and Ketjen black (registered trademark) for ensuring electron conductivity may be added to positive electrode layer 20. However, when the addition amount is large, the battery performance is influenced, so it is desirable that the addition amount is small enough not to influence the battery performance. A ratio of a total weight of solid electrolyte 1 and solid electrolyte 2 to a weight of positive electrode active material 3 is, for example, in a range of 50:50 to 5:95 for the total weight of solid electrolyte 1 and solid electrolyte 2:the weight of positive electrode active material, and may be in a range of 30:70 to 10:90. In addition, the volume ratio of positive electrode active material 3 to the total volume of positive electrode active material 3, solid electrolyte 1 and solid electrolyte 2 is, for example, 60% or more and 85% or less, and may be 70% or more and 85% or less. With this volume ratio, both a lithium ion conduction path and an electron conduction path in positive electrode layer 20 are likely to be ensured.

Positive electrode current collector 7 is made of, for example, a metal foil. As the metal foil, for example, a metal foil of SUS, aluminum, nickel, titanium, or copper is used.

### C-1. Solid Electrolyte

Each of solid electrolyte 1 and solid electrolyte 2 is optionally selected from at least one solid electrolyte material described in the above B-1. Solid Electrolyte. In addition, the selection of the material is not particularly limited. The material of each of solid electrolyte 1 and solid electrolyte 2 is selected, for example, within a range that does not significantly impair the ion conductivity at an interface where positive electrode active material 3 and solid electrolyte 1 are in contact with each other, and at an interface where two of solid electrolyte 1, solid electrolyte 2, and solid electrolyte 6 are in contact with each other.

Here, a relationship among average particle diameters of solid electrolyte 1, solid electrolyte 2, and positive electrode active material 3 to be described later is, for example, solid electrolyte 1<solid electrolyte 2<positive electrode active material 3.

For example, the average particle diameter of solid electrolyte 1 is 0.04 μm or more and less than 0.2 μm, and the average particle diameter of solid electrolyte 2 is 0.2 μm or more and less than 1 μm.

### C-2. Binder

Since the binder is the same as the binder described above, the description thereof will be omitted.

### C-3. Positive Electrode Active Material

Positive electrode active material 3 in the present embodiment will be described. As the material of positive electrode active material 3 in the present embodiment, for example, a lithium-containing transition metal oxide is used. Examples of the lithium-containing transition metal oxide include LiCoO₂, LiNiO₂, LiMn₂O₄, LiCoPO₄, LiNiPO₄, LiFePO₄, LiMnPO₄, and a compound obtained by substituting the transition metal of the above compounds with one or two different elements. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compound obtained by substituting the transition metal of the above compounds with one or two different elements. The materials of positive electrode active material 3 may be used alone or in combination of two or more thereof.

Positive electrode active material 3 is composed of, for example, a plurality of particles. The particles of positive electrode active material 3 are granulated particles in which a plurality of primary particles made of the above material are collected, and in the present specification, these granulated particles are referred to as the particles of positive electrode active material 3. Here, the average particle diameter of the particles of positive electrode active material 3 is not particularly limited, and is, for example, 1 μm or more and 10 μm or less.

### D. Negative Electrode Layer

Next, negative electrode layer 30 in the present embodiment will be described. Negative electrode layer 30 of the present embodiment contains solid electrolyte 5 and negative electrode active material 4. If necessary, a binder and a conductive aid such as acetylene black and Ketjen black for ensuring electron conductivity may be added to negative electrode layer 30. However, when the addition amount is large, the battery performance is influenced, so it is desirable that the addition amount is small enough not to influence the battery performance. The ratio of solid electrolyte 5 to negative electrode active material 4 is, for example, in a range of 5:95 to 60:40 for solid electrolyte 5:negative electrode active material 4 in terms of weight, and may be in a range of 30:70 to 50:50. In addition, the volume ratio of negative electrode active material 4 to the total volume of negative electrode active material 4 and solid electrolyte 5 is, for example, 60% or more and 80% or less. With this volume ratio, both a lithium ion conduction path and an electron conduction path in negative electrode layer 30 are likely to be ensured.

Negative electrode current collector 8 is made of, for example, a metal foil. As the metal foil, for example, a metal foil such as SUS, copper, or nickel is used.

### D-1. Solid Electrolyte

Solid electrolyte 5 is optionally selected from at least one solid electrolyte material described in the above B-1. Solid Electrolyte, and others are not particularly limited.

### D-2. Binder

Since the binder is the same as the binder described above, the description thereof will be omitted.

### D-3. Negative Electrode Active Material

Negative electrode active material 4 in the present embodiment will be described. As the material of negative electrode active material 4 in the present embodiment, for example, known materials such as an easily alloyed metal with lithium such as indium, tin, and silicon, a carbon material such as hard carbon and graphite, lithium, or Li₄Ti₅O₁₂ and SiOₓ are used.

Negative electrode active material 4 is composed of, for example, a plurality of particles. The average particle diameter of the particles of negative electrode active material 4 is not particularly limited, and is, for example, 1 μm or more and 15 μm or less.

### Manufacturing Method

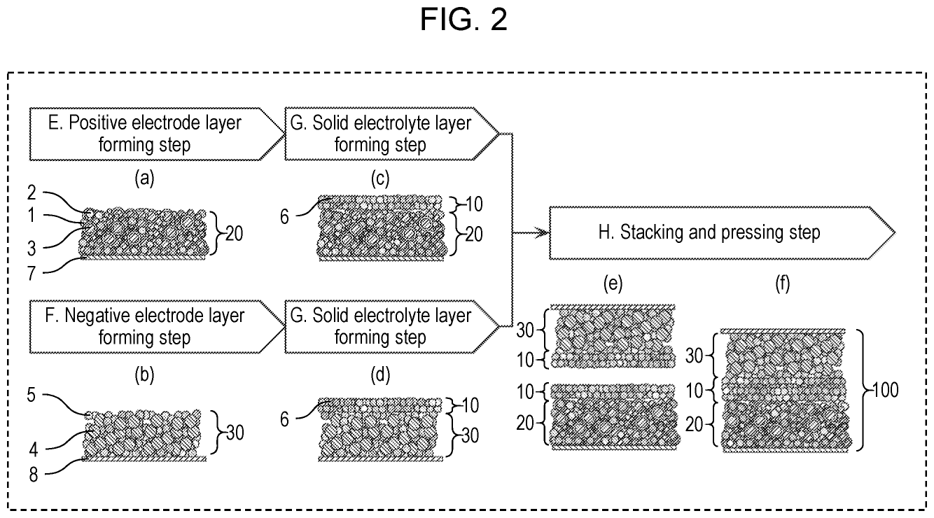

Next, a method for manufacturing all-solid-state battery 100 according to the present embodiment will be described with reference to FIG. 2. Specifically, the method for manufacturing all-solid-state battery 100 including positive electrode layer 20 and negative electrode layer 30 will be described. FIG. 2 is a schematic cross-sectional view illustrating the method for manufacturing all-solid-state battery 100.

The method for manufacturing all-solid-state battery 100 includes, for example, a positive electrode layer forming step, a negative electrode layer forming step, a solid electrolyte layer forming step, a stacking step, and a pressing step. In the positive electrode layer forming step ((a) in FIG. 2), positive electrode layer 20 is formed on positive electrode current collector 7. In the negative electrode layer forming step ((b) in FIG. 2), negative electrode layer 30 is formed on negative electrode current collector 8. In the solid electrolyte layer forming step ((c) and (d) in FIG. 2), solid electrolyte layer 10 is prepared. In the stacking step and the pressing step ((e) and (f) in FIG. 2), positive electrode layer 20 formed on positive electrode current collector 7, negative electrode layer 30 formed on negative electrode current collector 8, and prepared solid electrolyte layer 10 are stacked together such that solid electrolyte layer 10 is disposed between positive electrode layer 20 and negative electrode layer 30, and pressing is performed from the outer sides of positive electrode current collector 7 and negative electrode current collector 8. In addition, in order to prepare, for example, positive electrode active material 3, solid electrolyte 1, and solid electrolyte 2 used in the positive electrode layer forming step, the method for manufacturing all-solid-state battery 100 includes, for example, the first mixing step of mechanically applying a compressive force and a shearing force to positive electrode active material 3 and solid electrolyte 1, and the second mixing step of further adding solid electrolyte 2 to the mixture of positive electrode active material 3 and solid electrolyte 1 after the first mixing step and mechanically applying a compressive force and a shearing force. Hereinafter, each step will be described in detail.

### E. Positive Electrode Layer Forming Step

Examples of the step of forming positive electrode layer 20 (positive electrode layer forming step) in the present embodiment include the following two methods of method (1) and method (2).

(1) Positive electrode layer 20 in the present embodiment can be prepared by, for example, the step including a coating step of coating a slurry positive electrode mixture, which is prepared by dispersing positive electrode active material 3, solid electrolyte 1 and solid electrolyte 2 in an organic solvent, and further dispersing a binder and a conductive aid (not shown) in the organic solvent as necessary, onto the surface of positive electrode current collector 7, a drying and firing step of removing the organic solvent by heating and drying the obtained coating film, and a coating film pressing step of pressing the dried coating film formed on positive electrode current collector 7.

A coating method for the slurry is not particularly limited, and examples thereof include known coating methods such as a blade coater, a gravure coater, a dip coater, a reverse coater, a roll knife coater, a wire bar coater, a slot die coater, an air knife coater, a curtain coater, an extrusion coater, and a combination thereof.

Examples of the organic solvent used for slurrying include, but are not limited to, heptane, xylene, and toluene, and a solvent that does not cause a chemical reaction with positive electrode active material 3 or the like may be appropriately selected.

The drying and firing step is not particularly limited as long as the organic solvent can be removed by drying the coating film, and a known drying method or firing method using a heater or the like may be adopted. The coating film pressing step is not particularly limited, and a known pressing step using a press machine or the like may be adopted.

(2) In addition, as another method of forming positive electrode layer 20 in the present embodiment, for example, a method including a mixture adjusting step, a powder stacking step, and a powder pressing step can be mentioned. In the mixture adjusting step, solid electrolyte 1, solid electrolyte 2 and positive electrode active material 3 in a powder state which are not slurried are prepared, a binder and a conductive aid (not shown) are further prepared as necessary, and the prepared materials are mixed while applying an appropriate compressive force and shear force to prepare the positive electrode mixture in which positive electrode active material 3, solid electrolyte 1 and solid electrolyte 2 are uniformly dispersed. In the powder stacking step, the obtained positive electrode mixture is uniformly stacked on positive electrode current collector 7 to obtain a stacked body. In the powder pressing step, the stacked body obtained in the powder stacking step is pressed.

When the positive electrode mixture in a powder state is manufactured in a stacked form, there is an advantage that a drying step is not necessary and a manufacturing cost is reduced, and the solvent that contributes to the battery performance of the all-solid-state battery does not remain in positive electrode layer 20 after formation.

Here, in both the above methods (1) and (2), in order to prepare the positive electrode mixture containing positive electrode active material 3, solid electrolyte 1 and solid electrolyte 2, as a preparation for formation, the method for manufacturing all-solid-state battery 100 includes, for example, a step of stirring and mixing positive electrode active material 3, solid electrolyte 1, and solid electrolyte 2 in a dry manner. Here, the stirring and mixing means a method of mixing the materials such as positive electrode active material 3, solid electrolyte 1, and solid electrolyte 2 while applying the compressive force and the shearing force, and is not particularly limited to this method. In addition, the purpose of this stirring and mixing step is to realize a configuration in which the cover layer made of a plurality of particles constituting solid electrolyte 1 is formed on the at least a part of the surface of positive electrode active material 3, and the at least a part of particles of the plurality of particles constituting solid electrolyte 2 are partially embedded in the cover layer in the form of piercing the cover layer.

In addition, the stirring and mixing step, i.e., the step of mixing while applying the compressive force and the shearing force is performed in two steps. Specifically, the stirring and mixing step includes the first mixing step of mechanically applying the compressive force and the shearing force to positive electrode active material 3 and solid electrolyte 1, and the second mixing step of further adding solid electrolyte 2 to the mixture of positive electrode active material 3 and solid electrolyte 1 after the first mixing step and mechanically applying a compressive force and a shearing force. In addition, in the stirring and mixing step, mixing is performed under a condition that the energy applied in the first mixing step, i.e., the energy used for applying the compressive force and the shearing force in the first mixing step, is larger than the energy applied in the second mixing step, i.e., the energy used for applying the compressive force and the shearing force in the second mixing step.

A specific mixing procedure and conditions will be described later.

### F. Negative Electrode Layer Forming Step

The step of forming negative electrode layer 30 (negative electrode layer forming step) in the present embodiment is the same as the forming step of positive electrode layer 20 described in the above E. Positive Electrode Layer Forming Step in the basic forming method except that the material to be used is changed to a material for negative electrode layer 30.

A method for manufacturing negative electrode layer 30 may be, for example, a method in which a negative electrode mixture obtained by mixing solid electrolyte 5, negative electrode active material 4, and a binder and a conductive aid (not shown) as necessary to form a slurry is coated onto negative electrode current collector 8 and then dried (method (1) in E. Positive Electrode Layer Forming Step). In addition, the method for manufacturing negative electrode layer 30 may be, for example, a method in which the negative electrode mixture in a powder state which is not slurried is stacked on negative electrode current collector 8 (method (2) in E. Positive Electrode Layer Forming Step).

When the negative electrode mixture in a powder state is manufactured in a stacked manner, there is an advantage that the drying step is not necessary and the manufacturing cost is reduced, and the solvent that contributes to a capacity of the all-solid-state battery does not remain in negative electrode layer 30 after formation.

### G. Solid Electrolyte Layer Forming Step

Solid electrolyte layer 10 in the present embodiment can be prepared, for example, by the same method as that of the above E. Positive Electrode Layer Forming Step except that the slurry is prepared by dispersing solid electrolyte 6 and a binder as necessary in an organic solvent, and the obtained slurry is coated onto positive electrode layer 20 and/or negative electrode layer 30 prepared as described above.

In an example shown in FIG. 2, solid electrolyte layer 10 is formed onto both positive electrode layer 20 and negative electrode layer 30, but solid electrolyte layer 10 is not limited to this, and solid electrolyte layer 10 may be formed onto either of positive electrode layer 20 and negative electrode layer 30. In addition, solid electrolyte layer 10 may be prepared on a substrate such as a polyethylene terephthalate (PET) film by the above method, and obtained solid electrolyte layer 10 may be stacked on positive electrode layer 20 and/or negative electrode layer 30.

### H. Stacking Step and Pressing Step

In the stacking step and the pressing step, positive electrode layer 20 formed on positive electrode current collector 7, negative electrode layer 30 formed on negative electrode current collector 8, and solid electrolyte layer 10, which are obtained by respective forming steps, are stacked (stacking step) such that solid electrolyte layer 10 is disposed between positive electrode layer 20 and negative electrode layer 30, and then pressed (pressing step) from the outer sides of positive electrode current collector 7 and negative electrode current collector 8, thereby obtaining all-solid-state battery 100.

A purpose of pressing is to increase the density of positive electrode layer 20, negative electrode layer 30, and solid electrolyte layer 10. By increasing the density, lithium ion conductivity and electron conductivity can be improved in positive electrode layer 20, negative electrode layer 30, and solid electrolyte layer 10, and all-solid-state battery 100 having good battery characteristics can be obtained.

### Detailed Manufacturing Method Example

Hereinafter, a detailed manufacturing method example for positive electrode layer 20 of all-solid-state battery 100 according to the present embodiment will be described, but the present disclosure is not limited to these manufacturing method examples. Specifically, the first mixing step and the second mixing step will be described in detail. Each manufacturing method example is carried out in a glove box in which a dew point is controlled to −45° C. or lower, or in a dry room.

First, a material of the positive electrode active material used for positive electrode active material 3 is selected from the materials of the positive electrode active material described in C-3. Positive Electrode Active Material described in the method for manufacturing all-solid-state battery 100 in the present embodiment described above, and the solid electrolyte material used for each of solid electrolyte 1 and solid electrolyte 2 is selected from the solid electrolyte material described in B-1. Solid Electrolyte. Here, the same material or different materials may be used for solid electrolyte 1 and solid electrolyte 2.

Here, it is important that the average particle diameter of solid electrolyte 2 is larger than the average particle diameter of solid electrolyte 1 at the time when positive electrode layer 20 is finally formed through the above stirring and mixing step, and the average particle diameter of solid electrolyte material used for each of solid electrolyte 1 and solid electrolyte 2 to be charged is not particularly limited.

Examples of methods for realizing the relationship between the average particle diameter of solid electrolyte 2 and the average particle diameter of solid electrolyte 1 include the following two methods.

(A) Solid electrolyte particles having a relatively small average particle diameter are selected as the solid electrolyte material of solid electrolyte 1, and solid electrolyte particles having a relatively large average particle diameter are selected as the solid electrolyte material of solid electrolyte 2, and the solid electrolyte particles are stirred and mixed.

Alternatively, (B) stirring and mixing is performed under a condition that the solid electrolyte material used in solid electrolyte 1 is finely grinded by increasing the energy supplied in the step of stirring and mixing solid electrolyte 1 and positive electrode active material 3 (that is, the first mixing step), then solid electrolyte 2 is further charged into the mixture of solid electrolyte 1 and positive electrode active material 3, and the solid electrolyte material used in solid electrolyte 2 is not grinded by weakening the energy supplied in the stirring and mixing step (that is, the second mixing step).

In the method for manufacturing an all-solid-state battery according to the present embodiment, an example to be performed in the method (B) is described below, but it is also effective to combine the method (A) and the method (B).

A mixing ratio of positive electrode active material 3 to total solid electrolytes, which is a total of solid electrolyte 1 and solid electrolyte 2, is, for example, in a range of 70:30 to 85:15 in terms of volume ratio and in a range of 70:30 to 90:10 in terms of weight ratio.

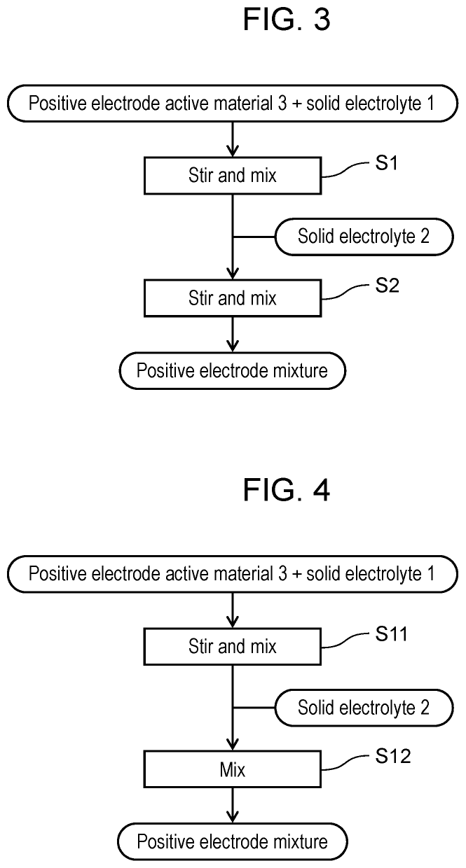

Here, for the mixing procedure, a difference between the method for manufacturing an all-solid-state battery in an embodiment and the method for manufacturing an all-solid-state battery in a comparative example will be described with reference to FIGS. 3 and 4. FIG. 3 is a flowchart showing the mixing procedure in the method for manufacturing an all-solid-state battery according to the embodiment. FIG. 4 is a flowchart showing the mixing procedure in the method for manufacturing an all-solid-state battery according to the comparative example.

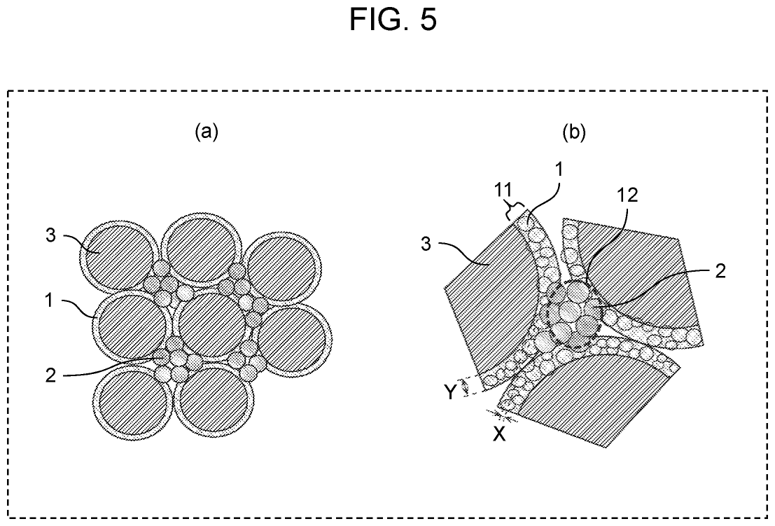

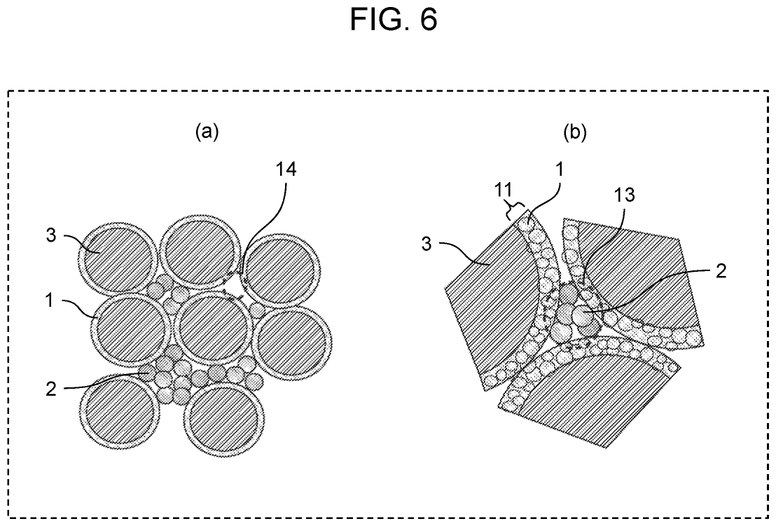

Positional relationships among positive electrode active material 3, solid electrolyte 1, and solid electrolyte 2, which are obtained by the mixing procedures shown in FIGS. 3 and 4, are shown in FIGS. 5 and 6, respectively. FIG. 5 is a schematic view showing the positional relationship among positive electrode active material 3, solid electrolyte 1 and solid electrolyte 2 obtained by the method for manufacturing an all-solid-state battery according to the embodiment. FIG. 6 is a schematic view showing the positional relationship among positive electrode active material 3, solid electrolyte 1 and solid electrolyte 2 obtained by the method for manufacturing an all-solid-state battery according to the comparative example. (a) in FIG. 5 and (a) in FIG. 6 are schematic views in a range of the number of particles of positive electrode active material 3, and (b) in FIG. 5 and (b) in FIG. 6 are schematic views in which gaps formed between the particles of positive electrode active material 3 are enlarged. In solid electrolyte 1 in (a) in FIGS. 5 and 6 and in a part of solid electrolyte 1 in (b) in FIGS. 5 and 6, the illustration of the shape of the plurality of particles is omitted as in FIG. 1.

### (I) MANUFACTURING METHOD ACCORDING TO EMBODIMENT

As shown in FIG. 3, in the mixing procedure of the method for manufacturing an all-solid-state battery in the present embodiment, first, as the first mixing step, positive electrode active material 3 and solid electrolyte 1 are stirred and mixed (step S1). Specifically, the positive electrode active material used for positive electrode active material 3 and the solid electrolyte material used for solid electrolyte 1 are charged into a stirring and mixing device. As the stirring and mixing device, for example, a device in which a rotary blade for stirring and mixing is provided in a container into which the material is to be charged is used. Then, a compressive force and a shear force are applied to the charged positive electrode active material used for positive electrode active material 3 and the charged solid electrolyte material used for solid electrolyte 1 by stirring and mixing. In the application of the compressive force and the shearing force in the first mixing step, for example, a processing energy of 1.5 kJ or more and 5.5 kJ or less is applied per 1 g of the total weight of charged positive electrode active material 3 and solid electrolyte 1. By the first mixing step, a cover layer composed of solid electrolyte 1 is formed on the at least a part of the surface of positive electrode active material 3. The cover layer will be described in detail later.

Here, the stirring and mixing is mixing in which a predetermined space is provided between an inner wall of the stirring and mixing device and the rotary blade, the material is supplied to the space, and the compressive force and the shearing force are applied to the material in the predetermined space by rotation of the rotary blade. Further, the processing energy (for example, unit: J), i.e., the energy used for the application of the compressive force and the shearing force is calculated, for example, as a product of a load power (for example, unit: W) and a processing time (for example, unit: s) applied to the rotary blade when the rotary blade is rotated at a predetermined rotation speed (i.e., the number of rotations per unit time). Specifically, the load power applied to the rotary blade is a difference between an electric power obtained when the rotary blade is rotated at a predetermined rotation speed without charging the material, and an electric power obtained when the material is charged and the rotary blade is rotated at the predetermined rotation speed. In addition, in the stirring and mixing operation, in order to prevent deterioration of the material due to heat generated during the stirring and mixing, it is also effective to perform the process step by step so as to appropriately stop the rotation of the rotary blade, cool and then rotate the rotary blade again.

Thereafter, as the second mixing step, solid electrolyte 2 is further added to the mixture of positive electrode active material 3 and solid electrolyte 1 obtained by stirring and mixing, and a compressive force and a shear force are applied again by stirring and mixing, so as to prepare a positive electrode mixture (step S2). Specifically, the solid electrolyte material used for solid electrolyte 2 is further added to the mixture of positive electrode active material 3 and solid electrolyte 1 in the stirring and mixing device. Then, the mixture of positive electrode active material 3, solid electrolyte 1, and the solid electrolyte material of solid electrolyte 2 are stirred and mixed at a rotation speed lower than the rotation speed of the rotary blade in the stirring and mixing in the first mixing step. In the application of the compressive force and the shearing force in the second mixing step, for example, a processing energy of 0.1 kJ or more and less than 1.5 kJ is applied per 1 g of the total weight of positive electrode active material 3 and solid electrolyte 1 charged in the first mixing step and solid electrolyte 2 charged in the second mixing step. Thus, the processing energy per unit weight in the first mixing step is larger than the processing energy per unit weight in the second mixing step. Accordingly, the positive electrode mixture containing positive electrode active material 3, solid electrolyte 1, and solid electrolyte 2 is prepared. In addition, in the positive electrode mixture prepared through the second mixing step, at least a part of particles of the plurality of particles constituting solid electrolyte 2 are partially embedded in the cover layer formed of solid electrolyte 1, which is formed on the surface of positive electrode active material 3. The positional relationship among such positive electrode active material 3, solid electrolyte 1, and solid electrolyte 2 will be described later in detail.

The method of stirring and mixing in the second mixing step and a concept of the processing energy are the same as those in the first mixing step.

Next, positive electrode layer 20 is formed by the method described in the positive electrode layer forming step by using the prepared positive electrode mixture. Then, the negative electrode layer forming step, the solid electrolyte layer forming step, the stacking step, and the pressing step are formed to manufacture all-solid-state battery 100.

Here, a charge amount of the solid electrolyte material used for solid electrolyte 1 and the solid electrolyte material used for solid electrolyte 2 is appropriately selected within the range of the mixing ratio of positive electrode active material 3 and the total solid electrolytes. For example, the mixing ratio of positive electrode active material 3 and the total solid electrolytes may be 50:50 to 95:5 in terms of weight ratio. In addition, in the total solid electrolytes, the ratio of the charge amount of the solid electrolyte material used for solid electrolyte 1 and the charge amount of the solid electrolyte material used for solid electrolyte 2 may be 10:90 to 90:10 in terms of weight ratio.

### (II) MANUFACTURING METHOD ACCORDING TO COMPARATIVE EXAMPLE

As shown in FIG. 4, in the mixing procedure of the method for manufacturing an all-solid-state battery in the comparative example, first, positive electrode active material 3 and solid electrolyte 1 are stirred and mixed in the same manner as in the first mixing step (step S11). Specifically, the charged positive electrode active material used for positive electrode active material 3 and the charged solid electrolyte material used for solid electrolyte 1 are stirred and mixed while applying a compressive force and a shearing force. In the application of the compressive force and the shearing force in step S11, for example, a processing energy of 1.5 kJ or more and 5.5 kJ or less is applied per 1 g of the total weight of the charged material of positive electrode active material 3 and the charged material of solid electrolyte 1. The method of stirring and mixing in the comparative example and the concept of the processing energy are the same as those in the first mixing step.

Then, solid electrolyte 2 is added and mixed to the mixture of positive electrode active material 3 and solid electrolyte 1 obtained by stirring and mixing, to prepare a positive electrode mixture (step S12). In the mixing in step S12, the compressive force and the shearing force are not substantially applied to the mixture of positive electrode active material 3, solid electrolyte 1, and solid electrolyte 2. That is, in the method for manufacturing an all-solid-state battery according to the comparative example, the positive electrode mixture is prepared without the second mixing step described above.

Next, positive electrode layer 20 is formed by the method described in the positive electrode layer forming step by using the prepared positive electrode mixture. As described above, in the method for manufacturing an all-solid-state battery according to the comparative example, the all-solid-state battery is manufactured by the same method as the method for manufacturing an all-solid-state battery according to the embodiment, except for the preparation of the positive electrode mixture.

### (III) POSITIONAL RELATIONSHIP AMONG POSITIVE ELECTRODE ACTIVE MATERIAL 3, SOLID ELECTROLYTE 1, AND SOLID ELECTROLYTE 2

The positional relationship among positive electrode active material 3, solid electrolyte 1, and solid electrolyte 2 in a cross-sectional view of each of positive electrode layers formed by the method for manufacturing an all-solid-state battery according to the above embodiment and the comparative example will be described with reference to FIGS. 5 and 6.

As shown in (a) and (b) in FIG. 5, in positive electrode layer 20 in the embodiment, cover layer 11 composed of solid electrolyte 1 is formed on at least a part of the surface of positive electrode active material 3, and at least a part of particles of the plurality of particles constituting solid electrolyte 2 are in a state of piercing cover layer 11 and being partially embedded therein. Here, cover layer 11 is a layer in which a plurality of fine particles of solid electrolyte 1 are pressed and fixed, and the solid electrolyte material of solid electrolyte 1 charged in the first mixing step is grinded by the energy applied in the stirring and mixing, and a plurality of fine particles formed by being grinded are in a state of being deposited in contact with the surface of positive electrode active material 3. When cover layer 11 is formed on the surface of positive electrode active material 3, a contact area between positive electrode active material 3 and solid electrolyte 1 is increased, and separation and insertion of the ions in positive electrode active material 3 are likely to occur. Cover layer 11 may be in a film shape such that the shape of a part of the fine particles of solid electrolyte 1 cannot be confirmed. In addition, the particles of solid electrolyte 1 not constituting cover layer 11 may be contained in positive electrode layer 20.

Since the at least a part of particles of solid electrolyte 2 are embedded and fixed in cover layer 11, the particles of solid electrolyte 2 are less likely to aggregate in manufacturing positive electrode layer 20, and dispersibility of solid electrolyte 2 is improved.

In addition, as shown in (b) in FIG. 5, in gaps 12 between positive electrode active materials 3 covered on cover layer 11, the particles of solid electrolyte 2 not embedded in cover layer 11 and exposed portions of the particles of solid electrolyte 2 partially embedded in cover layer 11 are filled. In addition, for example, there is a structure in which distance X in the figure, which is the shortest distance between the surface of positive electrode active material 3 and the surface of the particles of at least a part of solid electrolyte 2 in the particles of solid electrolyte 2 partially embedded in cover layer 11, is shorter than average thickness Y of cover layer 11. This relationship can be adjusted by the energy applied at the time of stirring and mixing after solid electrolyte 2 is added in the second mixing step. Specifically, it is important to apply the compressive force and the shearing force having enough energy to partially embed the particles of solid electrolyte 2 in cover layer 11 while preventing the grinding of the particles of solid electrolyte 2, and the energy used to apply the compressive force and the shearing force can be adjusted by the rotation speed, the processing time, and the like.

In contrast, as shown in (a) and (b) in FIG. 6, in the positive electrode layer in the comparative example, cover layer 11 formed of solid electrolyte 1 is formed on at least a part of the surface of positive electrode active material 3, as in the embodiment. In addition, as shown in (b) in FIG. 6, in gaps 13 between positive electrode active materials 3 covered on cover layer 11, the particles of solid electrolyte 2 are filled without being embedded in cover layer 11. Thus, in the positive electrode layer in the comparative example, since the particles of solid electrolyte 2 are not embedded in cover layer 11, the particles of solid electrolyte 2 are likely to be aggregated, and the dispersibility of solid electrolyte 2 in the positive electrode layer is reduced. As a result, there is likely to be a gap in which the particles of solid electrolyte 2 are not filled, such as gap 14 between the positive electrode active materials 3 covered on cover layer 11 shown in (a) in FIG. 6. Therefore, in the positive electrode layer in the comparative example, the ion conduction path between positive electrode active materials 3 is non-uniform.

### (IV) EXAMPLES

Next, results of evaluating the battery characteristics of the all-solid-state battery according to the present disclosure in Examples will be described, but the present disclosure is not limited to Examples. Specifically, all-solid-state batteries in Example 1 and Comparative Example 1 were prepared, and the battery characteristics of the prepared all-solid-state batteries were evaluated. The same material was used as the material of each constituent element of the all-solid-state batteries in Example 1 and Comparative Example 1. The all-solid-state battery in Example 1 was prepared by the method described in “(I) Manufacturing Method of Embodiment” described above. The all-solid-state battery in Comparative Example 1 was prepared by the method described in “(II) Manufacturing Method of Comparative Example” described above. That is, the all-solid-state battery in Comparative Example 1 was prepared by the same method as that of the all-solid-state battery in Example 1, except that the positive electrode mixture was prepared by adding and mixing solid electrolyte 2 to the mixture of positive electrode active material 3 and solid electrolyte 1 without the second mixing step described above.

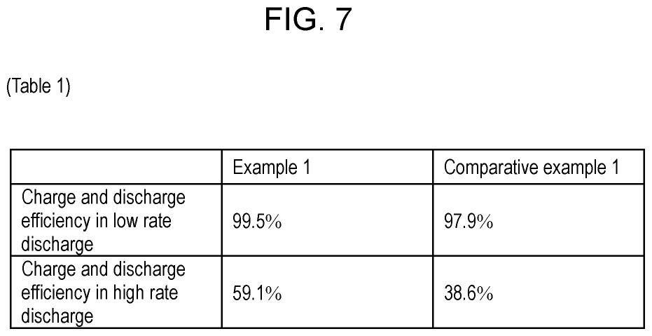

The results of evaluating charge and discharge efficiency as the battery characteristics of the all-solid-state batteries in Example 1 and Comparative Example 1 are shown in Table 1 of FIG. 7. In the evaluation of the charge and discharge efficiency, the charge and discharge efficiency was evaluated under two conditions of low rate discharge and high rate discharge. In addition, in the evaluation of the charge and discharge efficiency, charge was performed under conditions of a final voltage of 4.3 V, a current value of 0.05 C, and a temperature of 25° C., and discharge was performed under the conditions of a final voltage of 2.5 V, a current value of 0.05 C in a case of a low rate, a current value of 0.5 C in a case of a high rate, and a temperature of 25° C. In addition, in the evaluation of the charge and discharge efficiency, the charge and discharge efficiency was calculated by starting from charge and calculating the ratio (%) of a discharge capacity to a charge capacity.

As shown in Table 1, it can be seen that the all-solid-state battery in Example 1 has improved charge and discharge efficiency than the all-solid-state battery in Comparative Example 1. This result is considered to be an effect in which, as described with reference to FIG. 5, the particles of solid electrolyte 2 are fixed to cover layer 11, whereby the aggregation of the particles of solid electrolyte 2 is prevented, and the dispersibility of solid electrolyte 2 is improved, and thus gaps 12 between positive electrode active materials 3 are likely to be filled. That is, it is considered that the ion conduction path between positive electrode active materials 3 in positive electrode layer 20 is likely to be uniformly formed, the utilization efficiency of positive electrode active material 3 is improved, and the charge and discharge efficiency in low rate discharge is improved.

It is considered that in cover layer 11 which is formed of an aggregate of the particles of solid electrolyte 1 and in which the ion conductivity is likely to decrease due to an influence of the interface or the like, when the surface of the bulk particles of solid electrolyte 2, in which to the ions are more likely to be conducted than in cover layer 11, approaches the vicinity of the surface of positive electrode active material 3, the distance that the ions pass through cover layer 11 is shorter than that of the comparative example, and there is an effect of improving the ion conductivity in entire positive electrode layer 20. Therefore, it is considered that the charge and discharge efficiency in high rate discharge is also improved. That is, it is considered that, in (b) in FIG. 5, the distance X, which is the shortest distance between the surface of the at least a part of particles of the plurality of particles of solid electrolyte 2 and the surface of positive electrode active material 3, is shorter than average thickness Y of cover layer 11, so that the charge and discharge efficiency is improved.

Further, the configuration of positive electrode layer 20 in all-solid-state battery 100 for efficiently obtaining the above effects will be described below.

At least a part of particles of the plurality of particles constituting solid electrolyte 2 are partially embedded in cover layer 11 in the form of piercing cover layer 11, and the depth of the at least a part of particles partially embedded in cover layer 11 is, for example, 10% or more of the average particle diameter of solid electrolyte 2. Accordingly, the particles of solid electrolyte 2 are likely to be fixed to cover layer 11, the dispersibility of solid electrolyte 2 is improved, and the charge and discharge efficiency of all-solid-state battery 100 is improved. In addition, the surface of the particles of solid electrolyte 2 is likely to approach the surface of positive electrode active material 3, and the decrease in ion conductivity in positive electrode layer 20 can be prevented, so that the decrease in charge and discharge efficiency in high rate charge and discharge can be prevented. From the viewpoint of further improving the charge and discharge efficiency of all-solid-state battery 100, the depth of the at least a part of particles partially embedded in cover layer 11 may be 15% or more.

Regarding the relationship between the average particle diameters of solid electrolyte 1 and solid electrolyte 2, the average particle diameter of solid electrolyte 2 is, for example, five times or more the average particle diameter of solid electrolyte 1. Accordingly, gaps 12 between positive electrode active materials 3 on which cover layer 11 is formed are likely to be efficiently filled with solid electrolyte 2. Specifically, when the average particle diameter of solid electrolyte 2 is small, aggregation properties of the particles of solid electrolyte 2 are enhanced, and the particles of solid electrolyte 2 are likely to be unevenly distributed in positive electrode layer 20. As a result, a gap in which solid electrolyte 2 is not partially present is likely to be generated between positive electrode active materials 3. Further, when the average particle diameter of solid electrolyte 2 is small, if an operation (second mixing step) of fixing the particles of solid electrolyte 2 to cover layer 11 described above is performed, fine adjustment of the depth in which the particles are embedded is difficult, and the particles in the particles of solid electrolyte 2 are likely to be embedded in cover layer 11 in a large volume. Therefore, it is less likely to ensure the volume of the particles of solid electrolyte 2 to be filled in the gap formed between positive electrode active materials 3, i.e., the particles of solid electrolyte 2 exposed from cover layer 11. Therefore, since the average particle diameter of solid electrolyte 2 is increased, the aggregation of the particles of solid electrolyte 2 in manufacturing positive electrode layer 20 is prevented, and the particles of solid electrolyte 2 are prevented from being completely embedded in cover layer 11. Therefore, gaps 12 between positive electrode active materials 3 are likely to be efficiently filled with solid electrolyte 2. From the viewpoint that gaps 12 are more likely to be efficiently filled with solid electrolyte 2, the average particle diameter of solid electrolyte 2 may be six times or more the average particle diameter of solid electrolyte 1. In addition, the average particle diameters of solid electrolyte 1 and solid electrolyte 2 are both, for example, smaller than the average particle diameter of positive electrode active material 3. Accordingly, the space between positive electrode active materials 3 is efficiently filled with the solid electrolyte materials.

As described above, the all-solid-state battery according to the present disclosure has been described based on the embodiments, but the present disclosure is not limited to these embodiments. The embodiments in which a person skilled in the art applies various modifications to the embodiments and other forms that are constructed by combining some of the components in the embodiments are also included in the scope of the present disclosure within a range not departing from the gist of the present disclosure.

For example, in the above embodiment, an example in which the ions conducting in all-solid-state battery 100 are lithium ions has been described, but the present disclosure is not limited thereto. The ions conducting in all-solid-state battery 100 may be ions other than the lithium ions such as sodium ions, magnesium ions, potassium ions, calcium ions, and copper ions.

The all-solid-state battery according to the present disclosure is expected to be applied to various batteries, such as a power source of a mobile electronic device, and an in-vehicle battery.

What is claimed is:

1. An all-solid-state battery, comprising:
a positive electrode current collector;
a positive electrode layer containing
a positive electrode active material,
a first solid electrolyte comprising a plurality of first particles having a first average particle diameter, and
a second solid electrolyte comprising a plurality of second particles having a second average particle diameter larger than the first average particle diameter;
a solid electrolyte layer containing a fourth solid electrolyte;
a negative electrode layer containing a negative electrode active material and a third solid electrolyte; and
a negative electrode current collector,
wherein the positive electrode current collector, the positive electrode layer, the solid electrolyte layer, the negative electrode layer, and the negative electrode current collector are stacked in this order,
at least a part of the first solid electrolyte serves as a cover layer covering at least a part of a surface of the positive electrode active material, and
at least one of the plurality of second particles are partially embedded in the cover layer.

2. The all-solid-state battery of claim 1, wherein
a shortest distance between a surface of the at least one of the plurality of second particles and the at least a part of the surface of the positive electrode active material covered by the cover layer is shorter than an average thickness of the cover layer.

3. The all-solid-state battery of claim 1, wherein
a depth at which the at least one of the plurality of second particles is embedded is 10% or more of the second average particle diameter.

4. The all-solid-state battery of claim 1, wherein
the second average particle diameter is five times or more the first average particle diameter.

5. A method for manufacturing the all-solid-state battery of claim 1, comprising:
a first mixing step of mechanically applying a compressive force and a shearing force to the positive electrode active material and the first solid electrolyte; and
a second mixing step of further adding the second solid electrolyte to a mixture of the positive electrode active material and the first solid electrolyte after the first mixing step and mechanically applying a compressive force and a shearing force, wherein
energy used for applying the compressive force and the shearing force in the first mixing step is larger than energy used for applying the compressive force and the shearing force in the second mixing step.
